(19) United States
(12) Patent Application Publication
(10) Pub. No.: US 2009/0175028 A1
(43) Pub. Date: Jul. 9, 2009

(54) Backlight module having an optical film set with two-film structure

(75) Inventors: Lung-Shiang Luh, Suzhou (CN); Ching-Hua Ting, Suzhou (CN); Chien-Fa Tung, Suzhou (CN); Yu Feng, Suzhou (CN)

Correspondence Address: BACON & THOMAS, PLLC, 625 SLATERS LANE, FOURTH FLOOR, ALEXANDRIA, VA, 22314-1176, US

(73) Assignee: Core-Flex Optical (Suzhou) Co.,Ltd, Suzhou (CN)

(21) Appl. No.: 12/292,414

(22) Filed: Nov. 19, 2008

(30) Foreign Application Priority Data
Jan. 8, 2008 (CN) 200810032366.1

(51) Int. Cl. G02F 1/13357

(52) U.S. Cl. 362/97.2

(57) ABSTRACT

A backlight module is used to supply a light beam to a liquid crystal panel. The backlight module includes an optical film set. The optical film set includes a diffusion film for diffusing the light beam; a prism sheet for receiving the light beam from the diffusion film and propagating the light beam to the liquid crystal panel. The prism sheet is close to the liquid crystal panel, and has a plurality of projections, whose cross section is in cone-shape, disposed on a surface thereof adjacent to the liquid crystal panel. Some of the projections have a plurality of defects.

### BACKGROUND OF THE INVENTION

(1) Field of the Invention

The present invention relates to a backlight module for a flat-panel display device, particularly to an optical film set of the backlight module.

(2) Description of the Prior Art

Normally, a flat-panel display device such as liquid crystal display (LCD) mainly includes plural color filter sheets, a backlight module, a driving circuit IC, a compensation film, a polarizer, a liquid crystal panel (including glass substrate, ITO film and alignment film) and a control circuit. The liquid crystal panel relies on the backlight module assistance to achieve the display function because of no light illumination itself. Therefore, after the glass substrate fabricated and combined with the color filter sheets in sealingly laminated manner by liquid crystal panel producer, the space therebetween is filled with the liquid crystal materials; then, the result structure is integrated with the backlight module, the driving circuit IC and the control circuit orderly, so as to form a liquid crystal display module (LCM).

Currently, the primary light source for the backlight module includes cold cathode fluorescent lamps (CCFL), hot cathode fluorescent lamps (HCFL), light emitting diode (LED). The backlight module includes a light source, a lampshade, a reflector, a light guide plate, diffusion sheets, one or two pieces of prism sheet, and a frame housing. The diffusion sheets may include an upper one and a lower one, and the prism sheet is also called brightness enhancement film. The optical film set (including the diffusion sheets and prism sheets), and light guide plate dominate the critical technology and key cost for the backlight module. Owing to the advantages in thin thickness, light weight and compactness for easily carrying as well as low radiation for the LCD over those features of the current CRT comparatively, the LCD enjoys a significant market share with rapid increase in the display readout device market domain recently. Following the trend of the constantly improving production technology and keen marketing competition of vast size with low selling price, the product requirements in light weight, thin thickness, low power consumption, high brightness and low cost for the backlight module become inevitably essential and stringent. Accordingly, the research and development in innovative design and know-how of new injection molding production technology for the backlight module get into the crucial issues to be vigorously strived for.

Generally speaking, the backlight module is classified into two categories, namely front lighting category and back lighting category, wherein the back lighting category may be further divided into three types in accordance with the location of the light source, as belows:

(1). Side-emitting type, please refer to FIG. 2a. A single light source 102 is set at only one side of the backlight module. Abutting with the light source 102 is a light guide plate 102a. The light reflecting sheet 104 is located under the light guide plate 102a. The optical film set 106 (including an upper and a lower diffusion films and a prism sheet interposed therebetween), is located on the light guide plate 102. A liquid crystal panel 108 is disposed on the optical film set 106.

FIG. 2b shows another form of the side-emitting type, two light sources 102 are set at both sides of the backlight module. Compared to the side-emitting type shown in FIG. 2a, the side-emitting type of FIG. 2b provides better brightness.

(2). Bottom-emitting mode, please refer to FIG. 2c. The light beam coming from the light source 102 (for example, lamp or LED) travels to the liquid crystal panel 108 via a light reflecting sheet 104 and the diffusion films of the optical film set 106 orderly. Compared to the side-emitting type, the bottom-lighting type provides larger space for disposing two or more lamps depending upon the size of the liquid crystal panel.

Summarizing the foregoing description in association with the FIGS. 2a through 2c, the basic structure of the backlight module may be generalized into a norm structure as shown in the FIG. 1 that includes a light source 102b, the light reflecting sheet 104, the optical film set 106 and the liquid crystal panel 108. The light source 102b serves to supply or generate illuminating light desired. The light is reflected by the light reflecting sheet 104, and then travels to the optical film set 106. The optical film set 106 which usually includes diffusion films and the prism sheet, has functions of converging and diffusing the light beam for improving the brightness and blur effect. Finally, the processed light beam, which has been sequentially modulated via foregoing optical components, is propagated to the target liquid crystal panel 108 to serve as backlight.

As shown in the FIG. 3, the optical film set 106 aforesaid is usually laminated by three different function optical component layers that include a lower diffusion film 302, one or two prism sheets 304 or brightness enhancement films colloquially and an upper diffusion film 306 upwards orderly. The lower diffusion film 302 serves to diffuse the light beam coming from a light source and provides a partial light convergence in about 30%. The prism sheet 304 provides a partial light convergence in about 60% and improves the light blur effect so as to supply better backlight to the liquid crystal panel 108 with improved brightness and evenness. The upper diffusion film 306, which other than serves to diffuse the light beam, even additionally serves to protect the prism sheet 304 from scratch.

### SUMMARY OF THE INVENTION

The object of the present invention is to provide a backlight module with feature of being able to save the production process thereof.

In order to accomplish one, partial, complete or other objects, one embodiment of the present invention provides a backlight module, which is served to supply a light beam to a liquid crystal panel, basically includes an optical film set, which includes a diffusion film for diffusing the light beam and a prism sheet for converging and propagating the light beam to the liquid crystal panel, wherein, the prism sheet is close to the liquid crystal panel, and have a plurality of projections, whose cross section is in cone-shape, the projections disposed on a surface of the prism sheet, and the surface adjacent to the liquid crystal panel. Some of the projections have a plurality of defects.

The backlight module aforesaid further includes a frame housing providing for the optical film disposed therein; a light source disposed in the frame housing to supply light beam to the diffusion film; and a light reflecting sheet disposed in an inside wall of the frame housing, by which a part of the light beam incident to the inside wall of the frame housing is reflected toward the diffusion film.

Preferably, the prism sheet includes a plurality of additive particles; and the defects may be formed on the crests or at the troughs of the projections. Each of the defects is a pit or hump.

The other embodiment of the present invention renders a method for producing photocurable resin compound with high hardness for suitably making the prism sheet. The photocurable resin compound includes: 50-90% weight of bifunctional acrylate compound or multi-functional acrylate compound; 0-70% weight of mono-functional acrylate compound; and 0-10% weight of photo initiator.

The bifunctional acrylate compound, for example, is 1,4-butanediol diacrylate, 1,6-hexanediol diacrylate, neopentylglycol diacrylate, ethylene glycol diacrylate, triethyleneglycol diacrylate, and/or tetraethylene glycol diacrylate.

The multi-functional acrylate compound, for example, is trimethylolpropane triacrylate, glyceroltriacrylate, pentaerythritol triacrylate, pentaerythritol tetraacrylate and/or tris (2-acryloyloxyethyl) isocyanurate.

The mono-functional acrylate compound, for example, is ethylacrylate, n-butylacrylate, isobutylacrylate, 2-ethylhexylacrylate, n-hexylacrylate, n-octylacrylate, isobornyl acrylate, tetrahydrofurfuryl acrylate, 2-phenoxyethyl acrylate and/or N,N-dimethylacrylamide.

The photo initiator, for example, is benzyl, methyl o-benzoate, benzoin, benzoin ethyl ether, benzoin isopropyl ether, benzoin isobutyl ether, benzophenone/tertiary amine and acetophenones such as 2,2-diethoxyacetophenone, benzyl methyl ketal, 1-hydroxycyclohexyl phenyl ketone, 2-hydroxy-2-methyl-1-phenylpropan-1-one, 1-(4-isopropylphenyl)-2-hydroxy-2-methylpropan-1-one, 2-benzyl-2-N,N-dimethylamino-1-(4-morpholinophenyl)-1-butanone, 2,4,6-trimethylbenzoyldiphenylphosphine oxide and /or 2-methyl-1-4-(methylthio)phenyl-2-morpholion-1-propanone.

Thus, the embodiment of the present invention eliminates one upper diffusion film so that not only the production efficiency may be considerably improved due to saving one process step for fabricating upper diffusion film but also the backlight effect may be essentially enhanced owing to the prism sheets directly supplying light beams to the liquid crystal panel.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is the schematic view showing the structure of a conventional flat-panel display device in the prior art.

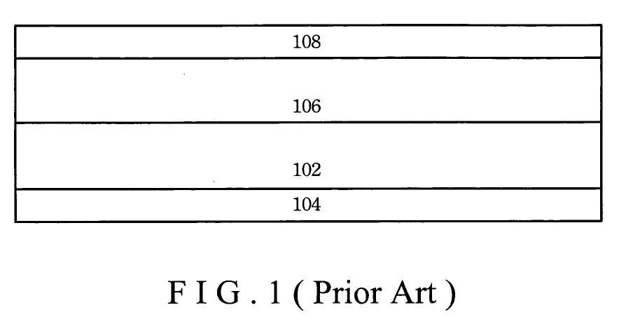

FIGS. 2a, 2b and 2c are the schematic views showing different applications of the conventional flat-panel display device according to the prior art.

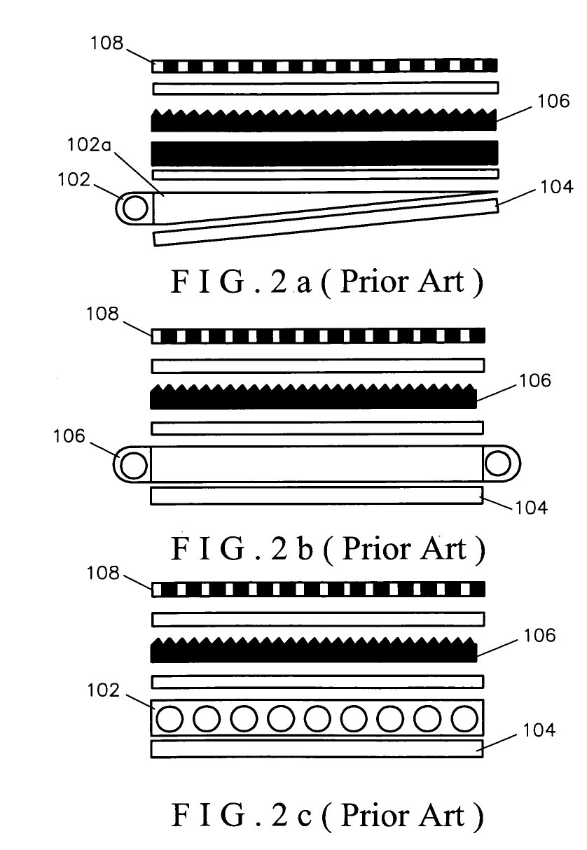

FIG. 3 is the schematic view showing the structure of the backlight module according to the prior art.

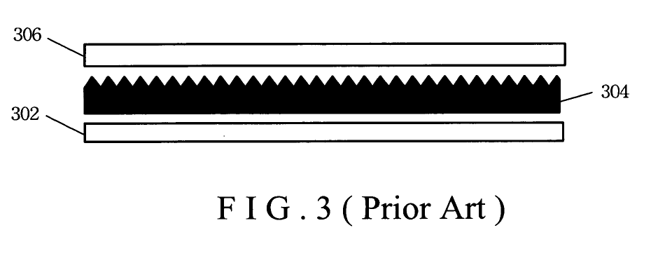

FIG. 4 is the schematic view showing the structure of a backlight module according to an embodiment of the present invention.

FIGS. 5a and 5b are the schematic views showing the blurred structures on the upper surface of the prism sheet in the backlight module according to an embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

A backlight module, which is provided by an embodiment of the present invention, basically includes a light supply/generating device and an optical film set. The light supply/generating device includes a light source, a light reflecting sheet and a frame housing. In one embodiment, the light supply/generating device further includes a light guiding sheet. The optical film set includes a diffusion film for diffusing light beam and a prism sheet for converging and propagating light beam to a liquid crystal panel. The prism sheet is closed to the liquid crystal panel, and has a plurality of projections, whose cross section is in cone-shape, disposed on a surface thereof adjacent to the liquid crystal panel. Some of the projections have a plurality of defects.

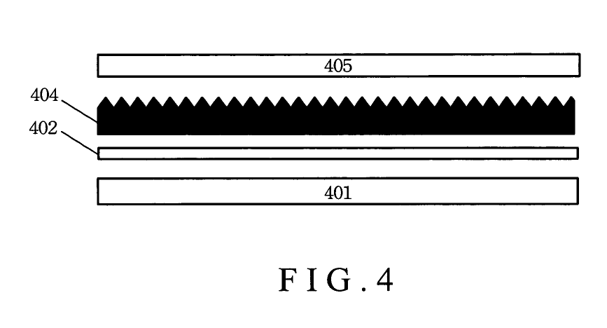

Please refer to the FIG. 4. The light supply/generating device 401 supplies a light beam to the diffusion film 402. The diffusion film 402 receives and then diffuses the light beam from the light supply/generating device 401. The light beam either directly illuminates from the light source of the light supply/generating device 401 or indirectly reflects from a light reflector (not shown) of the light supply/generating device 401. The prism sheet 404, which is close to the liquid crystal panel 405 without any other diffusion films being interposed therebetween, receives the incident light beam from the preceding diffusion film 402, and the light beam is converged by the prism sheet 404.

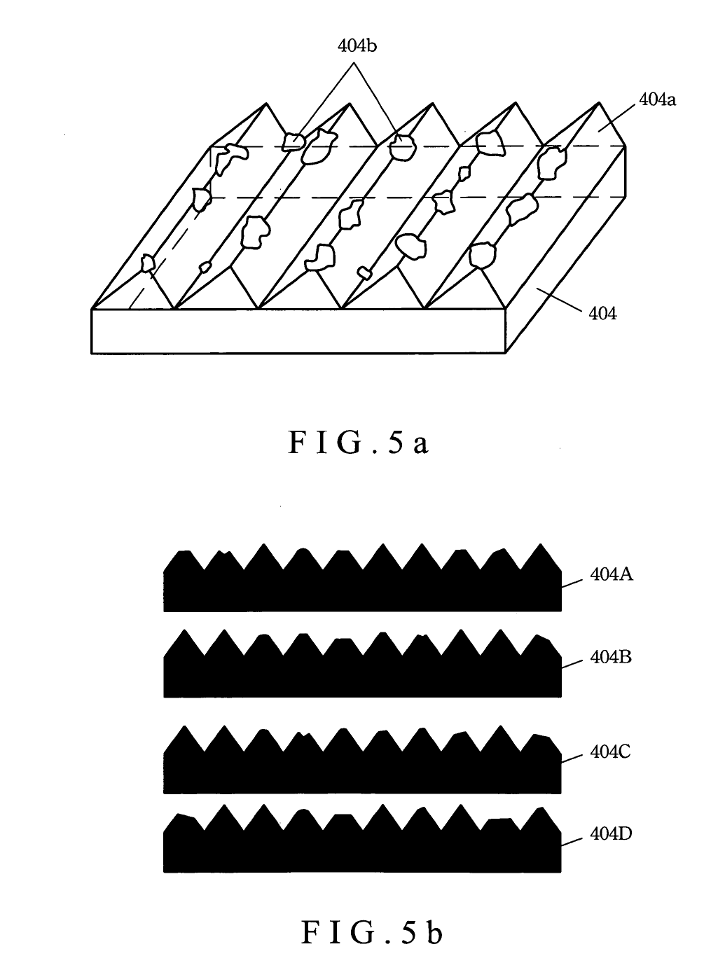

Please further refer to the FIG. 4 and FIG. 5a. The prism sheet 404 has plural projections 404a, whose cross section is in cone-shape, disposed on the surface thereof adjacent to the liquid crystal panel 405, and some of the projections 404a have plural defects 404b created thereon. One projection 404a may have defects 404b on the crest and/or trough thereof. Namely, some of the projections 404a just have defects 404b on the crest thereof, some of the projections 404a just have defects 404b on the trough thereof, some of the projections 404a have defects 404b on both crests and troughs thereof, or some of the projections 404a have no defects 404b. The defects 404b located on the top portions (also called crests) of the projections 404a are in form of pit, while the defects 404b located on the bottom portions (also called trough) of the projections 404a are in form of hump.

As shown in the FIG. 5b, the different morphological distributions of the defects 404b and the projections 404a are realized in four alterations 404A, 404B, 404C and 404D of the prism sheet 404, respectively.

In the exemplary embodiment, by means of the contrivance of the foregoing defects 404b disposed on the projections 404a, the light diffusing effect may be significantly enhanced so that the conventional upper diffusion film may be eliminated still remaining good light diffusing effect.

In an exemplary embodiment, in order to eliminate the conventional upper diffusion film with protection function, the material of the prism sheet 404 is required to have higher hardness with suitable optical properties for making the prism sheet 404 so that the product prism sheet 404 itself is hard enough with un-vulnerability. It should be stressed that the primary improvement of the present invention is focused on the optical film set, anyone of the rest structural components of the conventional backlight module may be compatibly integrated with the optical film set of the present invention.

In an exemplary embodiment of the present invention, the photocurable resin compound is adopted to make the prism sheet 404. The photocurable resin compound includes:

50-90% weight of bifunctional acrylate compound or multi-functional acrylate compound;

0-70% weight of mono-functional acrylate compound; and

0-10% weight of photo initiator;

Wherein, the bifunctional acrylate compound, for example, is 1,4-butanediol diacrylate, 1,6-hexanediol diacrylate, neopentylglycol diacrylate, ethylene glycol diacrylate, triethyleneglycol diacrylate and tetraethylene glycol diacrylate.

The multi-functional acrylate compound, for example, is trimethylolpropane triacrylate, glyceroltriacrylate, pentaerythritol triacrylate, pentaerythritol tetraacrylate and tris(2-acryloyloxyethyl)isocyanurate.

The mono-functional acrylate compound, for example, is ethylacrylate, n-butylacrylate, isobutylacrylate, 2-ethylhexylacrylate, n-hexylacrylate, n-octylacrylate, isobornyl acrylate, tetrahydrofurfuryl acrylate, 2-phenoxyethyl acrylate and N,N-dimethylacrylamide.

The rest compositions for producing the photocurable resin compound, for example, include ethylenically unsaturated compounds and resins that specifically includes styrene, divinylbenzene, vinyl toluene, N-vinyl pyrrolidone, N-vinyl caprolactam, monoallyl, polyallyl and polymethallyl esters such as diallyl phthalate, diallyal adipate as well as amides of carboxylic acids such as N,N-diallyladipamide.

Wherein, the photo initiator includes photopolymerization initiators, which is mixable with acrylic compounds, including for example benzyl, methyl o-benzoate, benzoin, benzoin ethyl ether, benzoin isopropyl ether, benzoin isobutyl ether, benzophenone/tertiary amine and acetophenones such as 2,2-diethoxyacetophenone, benzyl methyl ketal, 1-hydroxycyclohexyl phenyl ketone, 2-hydroxy-2-methyl-1-phenylpropan-1-one, 1-(4-isopropylphenyl)-2-hydroxy-2-methylpropan-1-one, 2-benzyl-2-N,N-dimethylamino-1-(4-morpholinophenyl)-1-butanone, 2,4,6-trimethylbenzoyldiphenylphosphine oxide and 2-methyl-1-4-(methylthio)phenyl-2-morpholion-1-propanone.

In an embodiment, the photocurable resin compound may be produced by following ingredients and method:

Ingredient (A): 38.8% weight of polyurethane-methacrylate;

Ingredient (B): 24.3% weight of ethyl phenoxy acrylate together with 11.7% weight of acrylate of 4-(2-Phenylisopropyl) phenol adding ethylene oxide, EO;

Ingredient (C): 2.8% weight of 1-hydroxyl cyclohexyl-formyl-ketone;

Ingredient (D): 0.5% weight of Plysurf A-208B;

Ingredient (El): 10.7% weight of epoxy ethyl methacrylate from methacrylate reacting with bisphenol-A based di-glycidyl ether; and

Ingredient (E2): 11.2% weight of di-methacrylat of ethylene glyco from epoxy ethyl methacrylate reacting with bisphenol-A based polyoxy-ethylene.

Producing method: firstly put all the foregoing ingredients orderly into a reacting vessel with agitator for evenly blending into mixture, then keep stirring the mixture under temperature of 50-60° C. for 1 hour.

The properties from testing standard for product of photocurable resin compound produced by above method are shown as below:

Refractive Index is 1.550 under temperature of 25° C. according to the JIS K7105 test method.

Adhesion Grade is measured by Cross-Cut test using PET as substrate according to the JIS K5400 test method that no square on the sample is torn off.

According to the embodiment, the fabricating process of the prism sheet 404 by using the photocurable resin compound produced by above method as material is illustrated as below:

firstly take certain particles in 40 g of the photocurable resin compound and put into an agitator;

prepare the mixture of resins with additives (such as photo initiator or various additive particles) and progressively put into the agitator up to 2 kg, then adjust the impeller disk of the agitator as low as possible but without contacting with the internal bottom thereof;

stir the mixing contents in the agitator under temperature of 50-60 □ for 1 hour, then keep the agitator in still for eliminating the air bubbles;

spread the evenly agitated mixing contents aforesaid over the PET substrate (thickness is 175 micrometer) into coated laminate in accordance with the predetermined recipe formula for desired ratio of various particles to resin; and

press the coated laminate aforesaid into prism or lenticular structure, then photo-harden it by ultraviolet light up to hardness of 300˜600 mJ/cm2 to finish the final prism sheet 404 product.

One molecule of the photocurable resin compound contains at least two acrylates with chemical molecular structure as below:

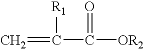

where, R1 may be alkyl;
R2 may be epoxy groups, glycol groups (including polyol), urethane groups (isocyanate/ polyol) or siloxy groups.

Some various additive particles in certain proportional ratio are added into the photocurable resin compound. The material of the additive particle may be selected from PC, PS, PMMA, PE or SiO2 . The diameter of the particle is 1-30 micrometer. The thickness of the PET substrate is 25-350 micrometer. In the following exemplary cases, the thickness of the PET substrate is 175 micrometer.

Table 1 lists the brightness value of the backlight based on the options of the ratios of the particle versus the photocurable resin compound in weight percentage, and also lists comparative backlight brightness ratio of the present invention versus conventional backlight module with 3-film structure in percentage expression for each corresponding selected additive particle.

TABLE 1

| Particle Weight | Backlight | Comparative Percentage |
|---|---|---|
| Percentage | Brightness | vs. Backlight Brightness |
| of selected | of Present | of conventional |
| Additive Particle | Invention | 3-film Structure |
| 0% | 6025 | 102.67% |
| 1% | 5783 | 98.43% |
| 2% | 5629 | 96.19% |
| 3% | 5483 | 94.36% |
| 5% | 5189 | 88.25% |
| 7% | 4972 | 85.02% |
| 10% | 4673 | 79.35% |

Where, the particle weight percentage of selected additive particle shown in the first column means the ratio of particle weight for each selected additive particle to the total weight of final blended mixture (various additive particles plus resin material) in percentage expression; and the conventional backlight module with 3-film structure means purchasable BEF III in the current market as prism sheet.

As shown in the Table 1, the backlight brightness with prism sheet for the present invention is affected by the particle weight percentage of selected additive particle. Compared to the conventional existing BEF III backlight module with 3-film structure, the additive particle blended concentration of 0%-10% in weight percentage range make the comparative backlight brightness ratio of the present invention versus the conventional 3-film structure in 79.35%-102.67% percentage range. It should be declared that the prism sheet 404 in the exemplary embodiment of the present invention has light diffusing function, so that it can effectively modulate the distribution of brightness from backlight module to provide for the liquid crystal panel. Other than the light diffusing effect, the prism sheet 404 may also improve the blur effect based on the brightness range of 79.35%-102.67% in corresponding to the additive particle blended concentration of 0%-10% in weight percentage range to meet different application requirements because prism sheet 404 has plural projections 404a and defects 404b irregularly dispersed over the surface thereof. For example, when the light passes through the produced prism sheet 404 and results in uneven converging effect, that is a part of the prism sheet 404 has larger light converging effect than other part thereof, the prism sheet 404 with additive particles may also improve the blur effect. Therefore, the production yield may be significantly promoted as some defective prism sheets 404 may be turned into usable qualified goods.

Thus, the embodiment of the present invention eliminates one upper diffusion film so that not only the production efficiency may be considerably improved due to saving one process step for fabricating upper diffusion film, but also the backlight effect may be essentially enhanced owing to the prism sheets directly supplying light beams to the liquid crystal panel.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, which is served to supply a light beam to a liquid crystal panel, the backlight module comprising an optical film set, the optical film set comprising:
a diffusion film for diffusing the light beam;
a prism sheet for converging and propagating the light beam to the liquid crystal panel,
wherein, the prism sheet is close to the liquid crystal panel, and has a plurality of projections whose cross section is in cone-shape, the projections disposed on a surface of the prism sheet, and the surface adjacent to the liquid crystal panel, wherein a part of the projections have a plurality of defects.

2. The backlight module as recited in the claim 1, further comprising:
a frame housing, providing for the optical film disposed therein;
a light source, disposed in the frame housing to supply light beam to the diffusion film; and
a light reflecting sheet, disposed in an inside wall of the frame housing, by which a part of the light beam incident to the inside wall of the frame housing is reflected toward the diffusion film.

3. The backlight module as recited in the claim 1 or 2, wherein the material of the prism sheet comprises a mixture of an additive particle and a resin.

4. The backlight module as recited in the claim 3, wherein the defects are formed on the crests of the projections.

5. The backlight module as recited in the claim 4, wherein each of the defects is a pit.

6. The backlight module as recited in the claim 3, wherein the defects are forms at the troughs of the projections.

7. The backlight module as recited in the claim 6, wherein each of the defects is a hump.

8. The backlight module as recited in the claim 1, wherein the prism sheet comprises photocurable resin compound comprising: 50-90% weight of bifunctional acrylate compound or multi-functional acrylate compound; 0-70% weight of mono-functional acrylate compound; and 0-10% weight of photo initiator.

9. The backlight module as recited in the claim 8, wherein the bifunctional acrylate compound is selected from the group consisting of 1,4-butanediol diacrylate, 1,6-hexanediol diacrylate, neopentylglycol diacrylate, ethylene glycol diacrylate, triethyleneglycol diacrylate and tetraethylene glycol diacrylate;
the multi-functional acrylate compound is selected from the group consisting of trimethylolpropane triacrylate, glyceroltriacrylate, pentaerythritol triacrylate, pentaerythritol tetraacrylate and tris (2-acryloyloxyethyl) isocyanurate; and
the mono-functional acrylate compound is selected from the group consisting of ethylacrylate, n-butylacrylate, isobutylacrylate, 2-ethylhexylacrylate, n-hexylacrylate, n-octylacrylate, isobornyl acrylate, tetrahydrofurfuryl acrylate, 2-phenoxyethyl acrylate and N,N-dimethylacrylamide.

10. The backlight module as recited in the claim 8, wherein the photo initiator is selected from the group consisting of benzyl, methyl o-benzoate, benzoin, benzoin ethyl ether, benzoin isopropyl ether, benzoin isobutyl ether, benzophenone/tertiary amine, acetophenones, benzyl methyl ketal, 1-hydroxycyclohexyl phenyl ketone, 2-hydroxy-2-methyl-1-phenylpropan-1-one, 1-(4-isopropylphenyl)-2-hydroxy-2-methylpropan-1-one, 2-benzyl-2-N,N-dimethylamino-1-(4-morpholinophenyl)-1-butanone, 2,4,6-trimethylbenzoyldiphenylphosphine oxide and 2-methyl-1-4-(methylthio)phenyl-2-morpholion-1-propanone.
